(19) United States
(12) Patent Application Publication
(10) Pub. No.: US 2008/0103855 A1
(43) Pub. Date: May 1, 2008

(54) System And Method For Detecting Anomalies In Market Data

(76) Inventors: Robert Hernandez, Philadelphia, PA (US); Gene Campbell, North Hanover, NJ (US); Cynthia Ann Stipa, Lansdale, PA (US)

Correspondence Address: BAKER BOTTS L.L.P., 30 ROCKEFELLER PLAZA, 44TH FLOOR, NEW YORK, NY, 10112-4498, US

(21) Appl. No.: 11/924,344

(22) Filed: Oct. 25, 2007

Related U.S. Application Data
(60) Provisional application No. 60/854,241, filed on Oct. 25, 2006.

(51) Int. Cl. G06Q 10/00

(52) U.S. Cl. 705/7

(57) ABSTRACT

A system and method for identifying data exceptions is disclosed. In some embodiments, data is monitored over a time period, a statistic is generated relating to the data, and it is determined whether the statistic exceeds a threshold In some embodiments, monitoring comprises monitoring the cost of a product or the sales volume of a product over a time period. In some embodiments, statistics may be generating regarding an outlier in the data, a directional trend in the data, or variability of the data.

### CROSS REFERENCE TO RELATED APPLICATIONS

This application claims priority to U.S. Provisional Application No. 60/854,241 entitled “Client View Exception and Analysis Tool and Methodology,” filed on Oct. 25, 2006, which is incorporated by reference in its entirety herein.

### BACKGROUND

1. Field

The present application relates to a systems and methods for detecting anomalies in the market data.

2. Background Art

Market data can be measured using several different types of data. For example, it may be measured by the average cost per unit of the product, or it may be measured the total quantity sold, or in the case of pharmaceuticals it may be measured by the total number of prescriptions given for a given product. These are just a few examples among many of ways in which market data on a product may be measured. However, not all market data-types accurately reflect actual market realities. For example, in the case of pharmaceuticals the total number of prescriptions issued may not accurately reflect an increase or decrease in demand for the product due to the method by which the drug is administered. This situation can present a serious problem in the case of suppliers and/or purchasers who rely on market data when making business decisions on quantities of a particular drug to purchase. Thus there is a need for a method to detect anomalies in market data: i.e., situations where different types of market data do not similarly reflect actually market realities.

### SUMMARY

Systems and methods for detecting anomalies in market data are disclosed herein.

In some embodiments, a method for detecting anomalies in one or more sets of market data is disclosed, which includes monitoring said one or more sets market data over a time period, generating one or more statistics relating to said one or more sets of market data, determining whether the said one or more statistics exceeds one or more corresponding thresholds to create one or more statistical exceptions; and prioritizing said one or more statistical exceptions.

In some embodiments, the monitoring includes monitoring cost of a product over said time period. In some embodiments, the monitoring includes monitoring sales volume of a product over said time period. In some embodiments, the generating one or more statistics includes generating one or more statistics regarding an outlier in the data. In some embodiments, the generating one or more statistics includes generating one or more statistics regarding a directional trend in the data. In some embodiments, the generating one or more statistics includes generating a statistic regarding variability of the data.

In some embodiments, a system for identifying anomalies in one or more sets of market data is disclosed including a data storage unit for storing data relating to one or more sets of market data; and a processor arranged and configured to monitor one or more sets market data over a time period, generate one or more statistics relating to said one or more sets of market data; determine whether the said one or more statistics exceeds one or more corresponding thresholds to create one or more statistical exceptions; and prioritize said one or more statistical exceptions.

In some embodiments, the processor is arranged and configured to monitor the cost of a product over a time period. In some embodiments, the processor is arranged and configured to monitor sales volume of a product over a time period. In some embodiments, the processor is arranged and configured to generate one or more statistics regarding an outlier in the data. In some embodiments, the processor is arranged and configured to generate one or more statistics regarding a directional trend in the data. In some embodiments, the processor is arranged and configured to generate a statistic regarding variability of the data. In some embodiments, the processor is arranged and configured to provide one or more notifications.

### BRIEF DESCRIPTION OF THE DRAWINGS

The accompanying drawings, which are incorporated and constitute part of this disclosure, illustrate some embodiments of the invention.

FIG. 1 illustrates a schematic diagram of the system in accordance with an embodiment of the present invention.

FIG. 2 illustrates a flow diagram in accordance with an embodiment of the present invention.

FIG. 3 illustrates flow diagram showing dependency relationships in accordance with an embodiment of the present invention.

FIG. 4 illustrates a component hierarchy model in accordance with an embodiment of the present invention.

FIG. 5 illustrates a flow diagram in accordance with an embodiment of the present invention.

FIGS. 6-7 illustrate graphs used for statistical analysis in accordance with an embodiment of the present invention.

### DETAILED DESCRIPTION

The following embodiments are all described with reference to the use of pharmaceutical data. However, it is envisioned that any type of data could be used in accordance with the present invention.

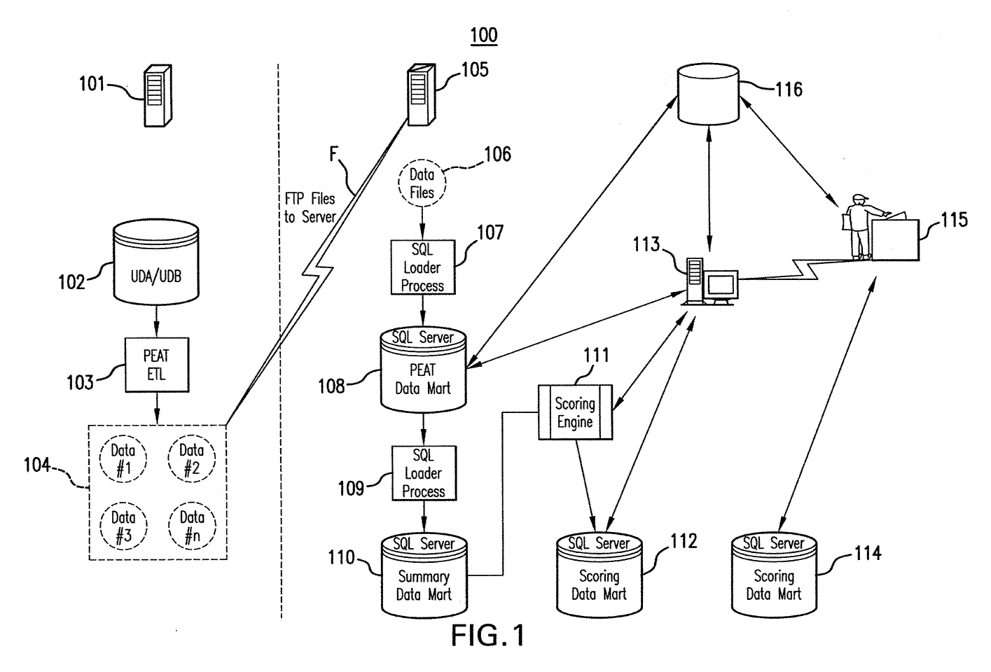

FIG. 1 is an exemplary embodiment of a system 100 for detecting anomalies in market data in accordance with the present invention. The system includes a server 101 for acquiring and storing data. In the exemplary embodiment, the server 101 may be a UNIX® server. On server 101 is a database system 102, which in an exemplary embodiment may contain a Universal Database Acquisition (UDA) and a Universal Database (UDB), for acquiring and storing market data. The database system 102 runs a process 103 to produce an extracted and transformed file set 104 of data from the database system 102. In an exemplary embodiment process 103 may consist of using a Product Exception and Analysis Tool (PEAT) to extract the data from a database, transform the data by aggregating it across one or more indicia, e.g., aggregating all prescriptions of a given drug dispensed by a given supplier over a certain period of time, and load the data onto a portion of the server capable of transferring the data (this process is herein referred to as extraction, transformation, and loading, or ETL). The server 101 is connected to another server 105, which in the exemplary embodiment is a NT® server. In an exemplary embodiment the server 101 transfers the extracted file set 104 to the server 105 by means of a file transfer protocol (FTP) (as indicated herein by arrow F).

On the server 105, data files 106 received from the server 101 are run through a process 107, which in an exemplary embodiment may be a structured query language (SQL) loader process, for the purpose of loading the data onto a database 108. In an exemplary embodiment database 108 may be a PEAT Data Mart, i.e., a database containing data extracted, transformed, and loaded (ETL) by using the Product Exception and Analysis Tool (PEAT), running on a SQL server and containing 13 rolling months of data. The PEAT Data Mart 108 is connected directly to a processor system 113, which in an exemplary embodiment is a computer system running a program for analyzing various data-types for business purposes. In an exemplary embodiment the program may be a custom designed Business Intelligence Tool Suite created using a statistical analysis software program, e.g., a SAS® program using SAS/QC, SAS/Base, and SAS/ODBC software modules. The computer system 113 may also be accessed by an audit team 115 for the purpose of further data analysis. The data contained in the PEAT Data Mart 108 may also be run through another process 109, which in an exemplary embodiment may be a SQL process that summarizes the data over one or more indicia, e.g., aggregates the total prescriptions dispensed by a particular supplier across all drugs, and then loads the data onto a database 109. In an exemplary embodiment database 109 may be a Summary Data Mart, i.e., a database containing data summarized over one or more indicia, running on a SQL server. The Summary Data Mart 109 is further connected to a database 112, which in an exemplary embodiment is a Scoring Data Mart, i.e., a database containing data analyzed for statistical exceptions, i.e., “scored” data, running on a SQL server. The Summary Data Mart 109 is connected to the Scoring Data Mart 112 via a process 111, which in an exemplary embodiment is a Scoring Engine, i.e., a process or program that generates statistics, or “scores”, for various data, determines whether the score exceeds a corresponding threshold and if so creates a statistical exception, and then ranks the exceptions. In an exemplary embodiment the Scoring Engine 111 may be part of a Business Intelligence Tool Suite running on a computer 113. The scores generated by the Scoring Engine 111 are then stored on the Scoring Data Mart 112. The Scoring Data Mart 112 is further connected to the computer system 113, which in an exemplary embodiment may serve purpose of allowing the audit team 115 to access the information contained thereon.

The audit team 115 may also have access to a database 114, which in an exemplary embodiment is another Scoring Data Mart running on a SQL server, either through the computer system 113 or through another processor system, for the purpose of further data analysis. It should be further noted that while FIG. 1 does not show a direct line between the Summary Data Mart 110 and the computer system 113, the invention envisions that all components of the system 100 may be directly accessed by the computer system 113. Furthermore, audit team 115 has access to a database 116, which in an exemplary embodiment is a Knowledge Database for storing “lessons learned”, i.e., improvements learned from past analyses, and which may further be connected to computer system 113 and PEAT Data Mart 108.

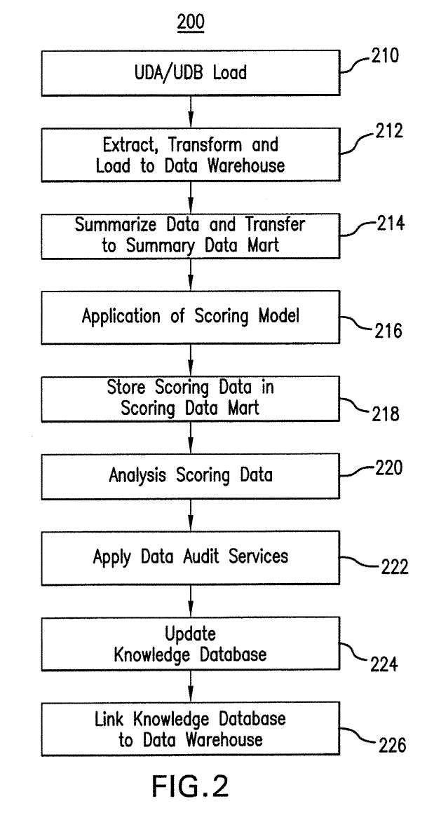

FIG. 2 is an exemplary flowchart 200 of a method for detecting anomalies in market data in accordance with the present invention. In the first step (210) the UDB and the UDA load. Next, data contained in a UDA database and UDB database are processed and loaded (212) into a Data Warehouse (e.g., the PEAT Data Mart of FIG. 1) 108, where in an exemplary embodiment the processing may consist of extracting the data from the database and aggregating the data, i.e., transforming the data, over one or more categories, e.g., by product or product supplier. Next, the data is summarized based on one or more relevant indicia (e.g., by product or by prescription plan) and transferred (214) to a Summary Data Mart 110. Then a Scoring Model (Engine) 111 is applied (216) to the summarized data, which is composed of the sub-steps of generating statistics, or “scores”, for various data, determining whether the score exceeds a corresponding threshold and if so creating a statistical exception, and then ranking the exceptions. In an exemplary embodiment the Scoring Engine 111 may be applied (216) as a part of the operation of a Business Intelligence Tool Suite running on a computer 113. Next, the scored data is stored (218) in a Scoring Data Mart 112. Then, a computer system 113 may analyze (220) the results of the Scoring Model application and generate a notification of the results viewable by a user. In an exemplary embodiment the analysis (220) and notification (221) may be performed by a Business Intelligence Tool Suite. Based on the analysis the an audit team 115 may apply various data audit services (222), such as adjusting the system, editing a matrix of changes, and documenting market trends. Furthermore, the audit team 115 may input (224) the newly acquired information into a Knowledge Database 116 that may contain “lessons learned” from the analysis and is further connected to the Data Warehouse 108 for the purpose of providing input (226) of early indicators of the market. Thus an information loop is formed, where the results of the data analysis may be applied back into the front of the system, further refining the analysis.

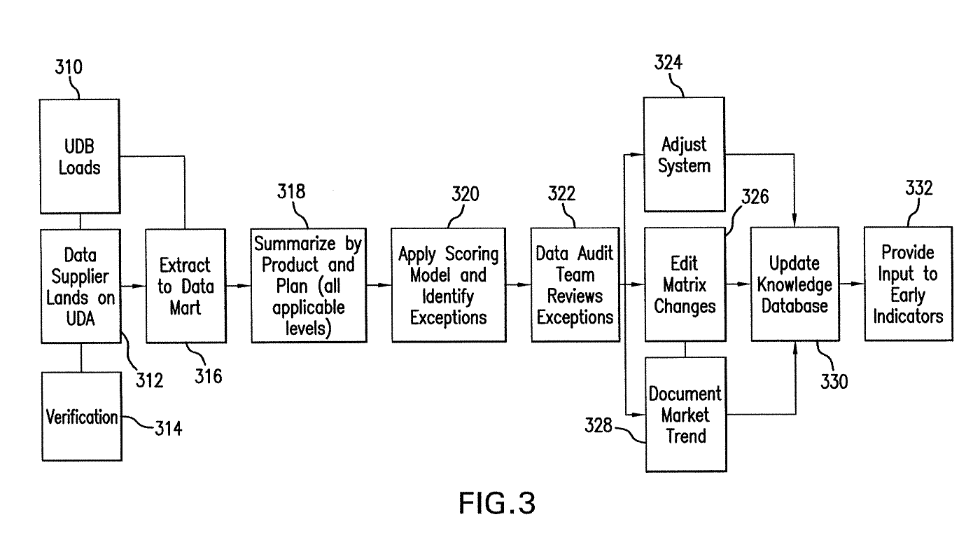

FIG. 3 is an exemplary flowchart 300 showing dependency relationships for the steps of a method for detecting anomalies in market data in accordance with the present invention. The input (332) of early indicators of the market is dependent on the updating (330) of the Knowledge Database 116 (shown in FIG. 1), which is in turn dependant on the application of one or more of the various data audit services (e.g., adjustment of system 324, editing of matrix changes 326, and documentation of market trends 328). The application of the one or more data audit services (324, 326, 328) is dependent on an audit team's 115 analysis (322) of the results of the application (320) of the Scoring Model (Engine) 111 and the identification (generation) (320) of statistical exceptions, which in turn depends on the summary (318) of the various data (e.g., by product and/or plan). This step depends on the extraction, transformation and loading (316) of the data from the UDA and the UDB, which in turn is dependant on the UDB loading (310) and the UDA being supplied with and loading (312) data, and may depend on the verification (314) of the data contained in those databases.

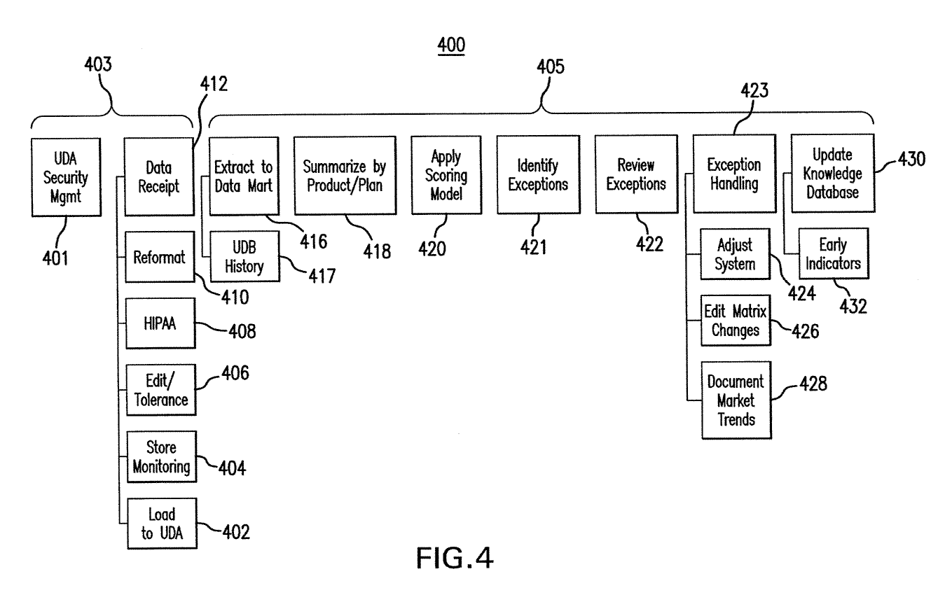

FIG. 4 shows a component hierarchy model 400 for a method for detecting anomalies in market data in accordance with the present invention. The UDA 403 has the component of UDA security management 401, which may be used to determine which users have access to the UDA 403. The UDA 403 has the further components, in hierarchical order from first in time to last in time, of data receipt 412, e.g., receiving raw data from data suppliers; reformatting (410) the data, e.g., altering the data so it is measured in consistent units of measurement; checking (408) the data for conformity with the Health Insurance Portability and Accountability Act (HIPAA); checking (406) the reformatted data against predetermined tolerances and editing the data to ensure it does not trigger a false statistical exception; monitoring (404) individual stores to determine if some are under/over performing others in one or more categories; and loading (402) the modified data onto the UDA 403. The UDA 403 and the Exception Tool 405 (i.e., the remainder of the system 100) share the components of extraction (416) to the Data Mart 108 and loading (417) of UDB history (i.e., data stored on the UDB). An exemplary embodiment envisions that the component of extraction (416) to the Data Mart entails extraction of UDA and UDB data.

The Extraction Tool 405 consists of the components of summarization (418) of products and/or plans, applying (420) the Scoring Model (Engine), identifying (421) the statistical exceptions, and reviewing (422) exceptions by the Data Audit Team. The Exception Tool 405 has the further components of exception handling 423, which may consists of adjusting (424) the system 100, editing (426) a matrix of changes, and documenting (428) market trends. The Exception also has the components of updating (430) the Knowledge Database 116 and inputting (432) the early indicators of market trends.

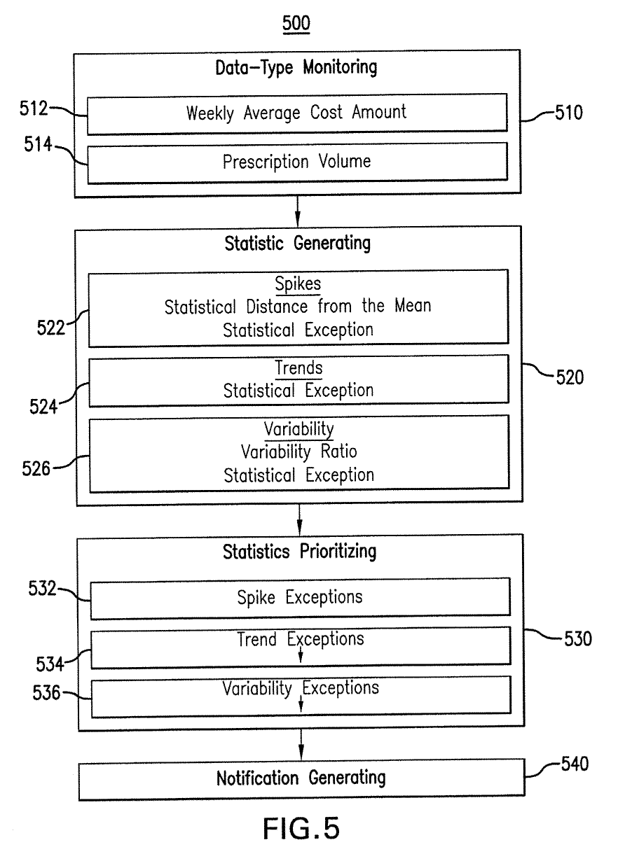

A detailed description of a method for applying the Scoring Model 111, for an exemplary embodiment, is described herein and illustrated in FIG. 5. In this or another embodiment the scoring process and exception generation and analysis for the UDA and/or UDB data may performed by utilizing one or more of the following techniques.

First, an embodiment may monitor one or more data-types at 510, e.g., monitoring Weekly Unit Average Cost Amount (i.e., the average cost of a given unit of a product measured weekly) at 512 and/or Prescription Volume (i.e., the total number of prescriptions dispensed in a given period of time, e.g., one week) at 514. Additionally, the same or another embodiment may perform such monitoring for one or more categories of data, e.g., all data of one data-type for a particular product supplier. Furthermore, the same or another embodiment may store such monitored data in one or more databases, e.g., the UDA and/or the UDB databases. Moreover, the same or another embodiment may use a processor system, e.g., a computer system 113, to monitor a given data-type over a given period of time to determine whether the data shows a particular trend. While some data-types may be monitored by direct acquisition of raw data, the monitoring of other data-types requires performing one or more calculations to one or more types of raw data. Examples of the monitoring of two data-types is detailed below.

According to one embodiment, data monitoring of Prescription Volume may be performed at 512. The data-type of Weekly Unit Average Cost Amount may be defined as the sum of the Outlet Cost Amounts (i.e., the cost to the store (supplier) of purchasing the drug), as measured over a predetermined period of time, e.g., a week, divided by the sum of the prescriptions dispensed (by the same store (supplier)), as measured over a predetermined period of time, e.g., a week. In the same or another embodiment the Weekly Unit Average Cost Amount may be aggregated across a particular data category, e.g., all Weekly Unit Average Cost Amount data for a particular product (e.g., a particular drug). In the same or another embodiment a mean may be calculated to by applying standard mathematic formulas to the data measured over the predetermined period of time, e.g., here the Weekly Unit Average Cost Amount Mean would be determined.

According to one embodiment, data monitoring of Prescription Volume may be performed at 514. The data-type of Prescription Volume may be defined as the total prescriptions dispensed over a predetermined period of time, e.g., once a week. In the same or another embodiment this value may be aggregated across a particular data category, e.g., all Prescription Volume data for a particular product supplier. In the same or another embodiment a mean may be calculated to by applying standard mathematic formulas to the data measured over the predetermined period of time, e.g., here Prescription Volume Mean would be determined.

Second, an embodiment may use a program, e.g., a Business Intelligence Tool Suite created using a statistical analysis software program (e.g., a SAS® program using SAS/QC, SAS/Base, and SAS/ODBC software modules), running on a processor system 113, e.g., a computer system, to generate a statistic, a “score”, relating to the monitored data described above at 520. The same or another embodiment may generate such a statistic (score) for upward or downward spikes in the data at 522, upward or downward trends in the data at 524, and/or variability of the data at 526.

A method for generating a statistic related to, i.e., scoring data, according to an exemplary embodiment, will be described herein. In one embodiment, identifying upward or downward spikes in the data (522) may involve specifying a period of time for analysis, e.g., the two most recent weeks of data. A subsequent stage in the method includes calculating the statistical distance from the mean value. If the difference of statistical distance from the mean value over the period of time, e.g., between the current week and previous week, is greater than a certain predetermined threshold value, an exception may be generated.

An example of the use of this method, according to an exemplary embodiment, follows below and is provided solely for illustrative purposes. For Product A the Prescription Volume Mean is 1,000 and the Standard Deviation is from the mean is 30, both calculated using the most current 16 weeks of data and standard formulas for calculating a mean and a standard deviation, respectively. For the current week, the Weekly Prescription Volume for Product A is 1,300. For the previous week, the Weekly Prescription Volume for Product A was 1,100. In this example the predetermined threshold value is 6.0. The first step is to calculate the Statistical Distance from the Mean for each Weekly Prescription Volume for Product A. The equation for calculating the Statistical Distance from the Mean appears below in equation [1]:
Statistical Distance from the Mean=(Weekly Prescription Volume−Prescription Volume Mean)/Standard Deviation [1]
The current week's Statistical Distance from the Mean is calculated as 10.0 for this example, i.e., (1,300−1,000)/30−10.0. The previous week's Statistical Distance from the Mean is calculated as 3.33 for this example, i.e., (1,100−1,000)/30=3.33. A next step is to determine if the difference between the current week's and previous week's Statistical Distance from the Mean is greater than the absolute value of the predetermined threshold value, e.g. 6.0. By this analysis, value differences greater than 6.0 are considered spikes based on the choice of a predetermined threshold value. In this case the current week's and previous week's statistical difference is calculated to be 6.67, i.e., (10.0−3.33)=6.67. Accordingly, an exception is generated, e.g., a spike value is declared.

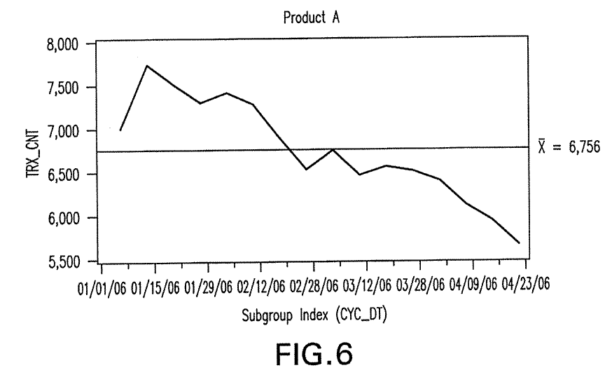

According to one embodiment, identification of upward or downward trends at 524 may involve determining if a particular data-type, as measured over a predetermined number of consecutive data points, show an upward or downward trend. In one exemplary embodiment six consecutive data points showing either an upward or downward trend may be considered significant enough to result in the generation of an exception. An upward or downward trend may be indicated by six consecutive data points, each being higher than the previous data point, or alternatively, six consecutive data points, each being lower than the previous data point. Alternatively, a downward or upward trend may indicated by the slope determined between data points. FIG. 6 illustrates an example of a graph of a downward trend of total prescription count (the Y-axis, labeled TRX-CNT) for a particular product, e.g., Product A. Sixteen data points are shown, one per week over a sixteen week period, and a downward trend of six consecutive data points is visible. To further clarify any trend, a mean line may be added to such a graph, as shown in FIG. 6 by the line X (having an exemplary value of 6,756). If such an exemplary situation arises, according to one embodiment, an exception may be generated as described in detail below.

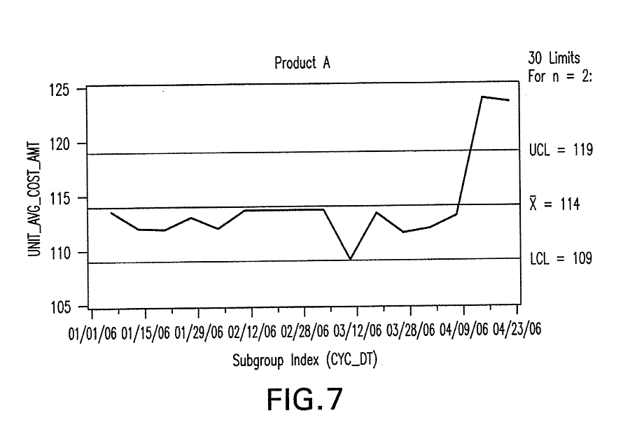

In the same or another embodiment identification of upward or downward trends may involve determining if one or more data points are above or below predetermined limits while the other data points are within the predetermined limits. In one exemplary embodiment if any data point exceeds three times the standard deviation of the mean the trend may be considered significant enough to result in the generation of an exception. FIG. 7 illustrates an example of a graph of a where some data points are above or below predetermined limits while other data points are within the predetermined limits. In FIG. 7, the Y-axis is the Weekly Unit Average Cost Amount (label UNIT_AVG_COST_AMT). The predetermined limits are represented as dashed lines UCL (the Upper Control Limit, having an exemplary value of 119) and LCL (the Lower Control Limit, having an exemplary value of 109), respectively. To further clarify any trend, a mean line may be added to such a graph, as shown in FIG. 7 by the line X (having an exemplary value of 114). Sixteen data points are shown, one per week over a sixteen week period, and two data points are clearly shown to be outside the predetermined limits of three times the standard deviation of the mean. If such an exemplary situation arises, according to one embodiment, an exception is generated.

According to one embodiment, identification of the variability of data at 526 may involve determining the variability of one or more data-types, e.g., Unit Average Cost Amount and Prescription Volume data. A subsequent stage may include calculating if the ratio of the variability of that data to the standard deviation from the mean value of that data is greater than a predetermined threshold value. An exception may be generated. According to the same or another embodiment the data may be associated with a particular data category, e.g., data relating to a particular product supplier.

An example of the use of this method in an exemplary embodiment follows below and is used solely for illustrative purposes. For Product A, the Prescription Volume Mean is 1,000 and the Standard Deviation is 30, both calculated using the most current 16 weeks of data and standard formulas for calculating a mean and a standard deviation, respectively. In this example the predetermined threshold value is 0.10. The Variability Ratio of Product A may be calculated using equation [2]:
Variability Ratio=(Standard Deviation/Prescription Volume Mean) [2]
Accordingly, for Product A, the Variability Ratio is calculated as 0.03, i.e., (30/1,000)=0.03. Here, the Variability Ratio is calculated to be less than 0.10, thus, according to one embodiment, an exception may not be generated.

Third, an embodiment may prioritize the statistical exceptions at 530 based on a criteria that data management personnel developed to address exceptions that are the most significant from a quality and market perspective. A method for prioritizing the exceptions, according to an exemplary embodiment, is described herein. According to an exemplary embodiment, the data category relating to particular products has the highest priority or ranking followed by the data category relating to particular product suppliers. The prioritized exceptions may be stored in a database, or provided as a visible output on a monitor or a printed output. Each of the steps described herein may be performed by one or more computers having a processor which is programmed to perform the steps described above.

According to the same or another embodiment, the exceptions within the respective product and product supplier categories may be prioritized in the following order: First, upward and downward spike exceptions may be assigned the highest priority at 532, e.g., the largest spike value may be assigned a ranking value of 1, the next largest spike value is assigned a ranking value of 2, and so on. Second, upward and downward trend exceptions may be assigned the next highest priority at 534, e.g., the highest percentage change ranked the highest may be assigned a ranking value equal to one less than the ranking value of the lowest ranked spike value. Third, variability exceptions may be assigned the next highest priority at 536, e.g., the highest Variability Ratio may be assigned a ranking value equal to one less than the ranking value of the lowest ranked trend value. The priorities described herein may be changed based upon, e.g., the requirements of the party analyzing the data.

Fourth, an embodiment may generate a notification at 540 corresponding to each generated exceptions. In the same or another embodiment a notification may be of a set of exceptions and further, may inform the user of the priority assigned to those exceptions. In the same or another embodiment a notification may only be generated for the highest priority exception, e.g., spikes that exceeded two times the threshold value. In some embodiment, the notification is viewable by a user of the invention. In some embodiments, the notification is audible to the user. In some embodiments, the notification is stored in a data file.

According to one embodiment and with regard to one or more databases, e.g., the UDA and UDB databases, notifications may be generated periodically. For example, in one embodiment, at a particular time, e.g., every Sunday night, the processing system 113 running a program, e.g., the Business Intelligence Tool Suite program, may load in a plurality of weeks worth of data, e.g., the sixteen most recent weeks. In the same or another embodiment such data may be in one or more data categories, e.g., in the category of product supplier data, and may be of one or more data-types, e.g., Unit Average Cost Amount and Prescription Volume data. Further, in the same or another embodiment the processing system 113 may generate an exception for the data for one or more data-types, e.g., Unit Average Cost Amount and Prescription (Rx) Volume data. This data may then be used by the processing system 113 running a program, e.g., the Business Intelligence Tool Suite program, to generate a notification of the exception which may be viewable by a user of the invention. The notification may be stored in a database, or provided as a visible output on a monitor or a printed output.

The following paragraphs illustrate further modifications and alterations that may exists in one or more embodiments of the present invention and are intended solely to illustrate the diversity of the present invention.

According to an exemplary embodiment, the UDA may contain only raw data and further may be limited to 13 weeks of prescription history. The UDA may feeds market data to the UDB, which may contain raw, imputed, and projected market data and may store 24 months of market data history.

The computer system 113 running a program, e.g., the Business Intelligence Tool Suite program, may have the capacity to perform an analysis of the scores for the various data types to determine any statistical outlying data values. In one embodiment the computer system 113 may further prioritize such outlying data values for user. In the same or another embodiment the user may have the ability to drill-down (i.e., narrow the scope of data being analyzed) on all statistical exceptions from the database to the channel and supplier level. In addition, in the same or another embodiment the user may have the ability to view the market data regionally. Moreover, in the same or another embodiment the user may have access to graphs for all statistics that are used for determining and tracking market trends. Furthermore, in the same or another embodiment the user may be able to view the history of monitored market data going back for as long as such data exists.

According to an exemplary embodiment, the user of the product in terms of the roles and responsibilities may be data management personnel responsible to manage and/or monitor data quality and market trends. According to the same or another embodiment, the user of the invention may be a data audit team 115, as shown in FIG. 1. Furthermore, according to the same or another embodiment, the invention may be used by data management executives to determine the quality of market data in relation to the market realities, provide proactive notice when key clients should expect trend breaks, validate market share for products and/or manufacturers, and identify relevant quality indicators and/or indicators of market trends.

In the same or another embodiment of the invention the data audit team 115 may use the invention to track whether the product market data show trends that are consistent in regards to volume, cost, price, and quantity; whether plans related to one or more products show trends that are consistent from a perspective of volume and unit sales; whether the cost received on a given prescription is comparable to a market reference point, e.g., average wholesale price or average sale price; whether there are any trend breaks or inconsistencies related to a particular supplier, channel, store, etc.; and the impact of trend breaks or inconsistencies on prescribes, plans, and/or products. The system may further provide statistics on the number, percent, and type of quantity conversions (i.e., converting all market data to the same units) based on a quantity edit reason code (i.e., the code that corresponds to the reason for converting the units). Furthermore, although all statistical exceptions may be based on the total prescriptions measured, it is contemplated that the user may still have the option of looking at “good”, e.g., valid, prescriptions only and to perform an analysis of why “bad,” e.g., invalid, prescription data is being excluded.

Data sources for an embodiment of the system or method may be external sources or existing system data sources. It is also envisioned that a conceptual data model may also be used. Prescription data may include retail, mail order, and long-term care data gathered by proprietary data services, e.g., a Next-Generation Prescription Services (NGPS); sales data may include data gathered by use of outside (non-proprietary) means, e.g., sales from warehouses to distributors such as Nation Sales Perspective (NSP) data and the raw data that is used for NSP; reference information data may include UDA and/or UDB data models and/or data dictionaries; and projection methodology data may include projection methodology data created by proprietary means, e.g., NGPS projection methodology data.

Information delivery for an embodiment of the system or method is described herein. With respect to measures, new metrics may be introduced starting with ‘cost per unit’, ‘cost per prescription (Rx)’, and ‘quantity per day.’ History requirements may be in synchronization with the UDB. The addition of the new UDA functionality described herein may not impact the existing time allotted for analyzing data.

According to the same or another embodiment the level of detail provided in a given database may conform to the existing level of detail in the UDA and/or UDB. With respect to time, statistical exceptions may be identified within and after the time allotted for analyzing data. In addition, geographical information may conform to the existing NGPS specifications. Also, no change to prescriber bridging is contemplated according to the embodiment described herein. Furthermore, processing of distribution channel information may conform to the existing NGPS specifications. Moreover, no change to plan/payor bridging is contemplated according to the embodiment described herein.

It will be understood that the foregoing is only illustrative of the principles of the invention, and that various modifications can be made by those skilled in the art without departing from the scope and spirit of the invention. For example, the system and methods described herein are used in connection with market trends for prescription data. It is understood that that techniques described herein are useful in connection with any data for detecting trends or anomalies. Moreover, features of embodiments described herein may be combined and/or rearranged to create new embodiments.

We claim:

1. A method for identifying anomalies in one or more sets of market data comprising:
monitoring said one or more sets of market data over a time period;
generating one or more statistics relating to said one or more sets of market data;
determining whether the said one or more statistics exceeds one or more corresponding thresholds to create one or more statistical exceptions; and
prioritizing said one or more statistical exceptions.

2. The method according to claim 1, wherein said monitoring comprises monitoring cost of a product over said time period.

3. The method according to claim 1, wherein said monitoring comprises monitoring sales volume of a product over said time period.

4. The method according to claim 1, wherein said generating one or more statistics comprises generating one or more statistics regarding an outlier in the data.

5. The method according to claim 1, wherein said generating one or more statistic comprises generating one or more statistics regarding a directional trend in the data.

6. The method according to claim 1, wherein said generating one or more statistic comprises generating a statistic regarding variability of the data.

7. The method according to claim 1, wherein determining whether the said one or more statistics exceeds one or more corresponding thresholds comprises generating a notification.

8. A system for identifying anomalies in one or more sets of market data comprising:
a data storage unit for storing data relating to one or more sets of market data; and
a processor arranged and configured to monitor one or more sets market data over a time period, generate one or more statistics relating to said one or more sets of market data; determine whether the said one or more statistics exceeds one or more corresponding thresholds to create one or more statistical exceptions; and prioritizing said one or more statistical exceptions.

10. The system according to claim 9, wherein the processor is arranged and configured to monitor the cost of a product over a time period.

11. The system according to claim 9, wherein the processor is arranged and configured to monitor sales volume of a product over a time period.

12. The system according to claim 9, wherein the processor is arranged and configured to generate one or more statistics regarding an outlier in the data.

13. The system according to claim 9, wherein the processor is arranged and configured to generate one or more statistics regarding a directional trend in the data.

14. The system according to claim 9, wherein the processor is arranged and configured to generate a statistic regarding variability of the data.

15. The system according to claim 9, wherein the processor is arranged and configured to provide one or more notifications.
